(19) United States
(12) Patent Application Publication
(10) Pub. No.: US 2023/0028225 A1
(43) Pub. Date: Jan. 26, 2023

(54) METHOD FOR MEASURING THE FLOW OF A LIQUID MEDIUM HAVING VARIABLE GAS CONTENT ON THE BASIS OF A DIFFERENTIAL-PRESSURE MEASUREMENT

(71) Applicant: Endress+Hauser Flowtec AG, Reinach (CH)

(72) Inventors: Stephan Schäfer, Freising (DE); Hao Zhu, Freising (DE)

(21) Appl. No.: 17/757,554

(22) PCT Filed: Dec. 1, 2020
(86) PCT No.: PCT/EP2020/084116

§ 371 Date: Jun. 16, 2022

(30) Foreign Application Priority Data
Dec. 19, 2019 (DE) 10 2019 135 320.3

(51) Int. Cl. G01F 1/50; G01F 15/04

(52) U.S. Cl. CPC G01F 1/50; G01F 15/046

(57) ABSTRACT

The present disclosure relates to a method for measuring the flow of a liquid medium having variable gas content, on the basis of a differential pressure measurement by means of a differential pressure-generating primary element, through which the medium flows, which method comprises: ascertaining a differential pressure measurement value between two measuring points of the differential pressure-generating primary element; ascertaining a flow regime; ascertaining a flow rate measurement value as a function of the differential pressure measurement value and the flow regime, wherein the flow rate measurement value is ascertained by ascertaining a provisional flow rate measurement value on the basis of the differential pressure measurement value under the assumption of a first flow regime, which provisional flow rate measurement value is corrected if a second flow regime different from the first flow regime is detected.

The present invention relates to a method for flow measurement on the basis of a differential-pressure measurement by means of a differential-pressure-generating primary element through which the medium flows.

This measuring principle is established prior art and described inter alia in: “Durchfluss-Handbuch” (Flow Manual), 4th Edition 2003, with ISBN 3-9520220-3-9. Flow measurement on the basis of a differential-pressure measurement has been established, for example, as a supplementary measuring principle for Coriolis mass flow measurement if a large gas content of a liquid medium adversely affects the measurement accuracy of the Coriolis mass flow sensors. The combination of these measuring principles is described, for example, in the published, non-examined patent application DE 10 2005 046 319 A1 and the still unpublished patent application having the file number DE 10 2018 130 182.0. The supplementary use of the differential-pressure measurement described in the aforementioned protective rights still has space for improvements, as the gas content of a liquid medium can adversely affect the measurement accuracy.

The object of the present invention is, therefore, to find a remedy here. The object is achieved according to the invention by the method according to independent claim 1.

The method according to the invention for measuring the flow of a liquid medium having variable gas content on the basis of a differential-pressure measurement by means of a differential-pressure-generating primary element through which the medium flows comprises: Ascertaining a differential-pressure measurement value between two measurement points of the differential-pressure-generating primary element; Ascertaining a flow regime; Ascertaining a flow rate measurement value as a function of the differential-pressure measurement value; and the flow regime.

In a further embodiment of the invention, the ascertainment of the flow regime comprises the determination of a gas volume fraction.

In a further embodiment of the invention, the ascertainment of the gas volume fraction comprises ascertaining at least one gas volume fraction selected from suspended bubbles, free bubbles and slugs.

In a further embodiment of the invention, the ascertainment of the flow regime is based on at least one measured variable that characterizes a medium property selected from the list of the following medium properties: density, viscosity, temperature, thermal capacity, thermal conductivity, electrical conductivity and pressure.

In a further embodiment of the invention, the ascertainment of the flow regime comprises an evaluation of temporal fluctuations or fluctuations of a measured variable that characterizes a medium property.

In a further embodiment of the invention, the density measurement value and the gas volume fraction are determined by means of a vibronic measuring sensor, in particular having a vibrating measuring tube.

In a further embodiment of the invention, the flow rate measurement value is ascertained by ascertaining a provisional flow rate measurement value on the basis of the differential-pressure measurement value under the assumption of a first flow regime, which provisional flow measurement value is corrected if a second flow regime different from the first flow regime is detected.

In a further embodiment of the invention, the provisional flow measurement value is further ascertained as a function of a density value and/or a viscosity value, wherein in particular the density value and/or the viscosity value is or are a density measurement value and/or the viscosity measurement value.

In a further embodiment of the invention, the correction is performed with a correction factor assigned to the flow regime.

In a further embodiment of the invention, the correction factor for at least one flow regime comprises a function specific to the flow regime that depends at least on a gas volume fraction.

In a further embodiment of the invention, the correction factors for a plurality of flow regimes each comprise a function specific for the flow regime, which depend at least on a gas volume fraction, wherein the functions of different flow regimes differ from one another.

In a further embodiment of the invention, the first flow regime comprises a flow of a single-phase medium.

The invention is now explained in more detail on the basis of the exemplary embodiments shown in the figures. The following are shown:

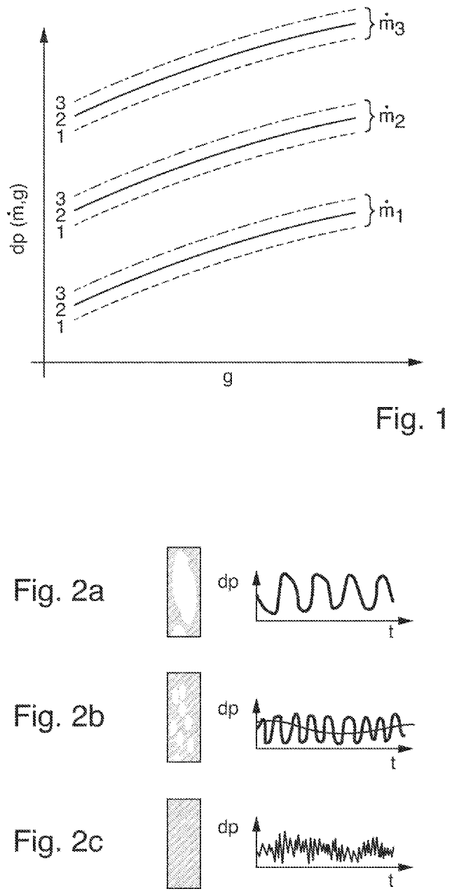

FIG. 1: A schematic representation of measurement results for the pressure drop at different mass flow rates as a function of gas content for various flow regimes;

FIG. 2a to c: Schematic diagrams of various flow regimes and the associated time profiles of the differential-pressure, including:

FIG. 2a: Slug flow FIG. 2b: Free bubbles

FIG. 2c: Suspended microbubbles or homogeneous liquid

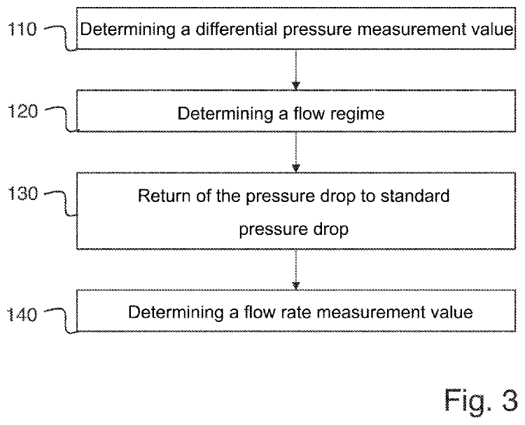

FIG. 3: a flow diagram of an exemplary embodiment of the method according to the invention.

FIG. 1 schematically shows the pressure drop dp at a differential-pressure-generating primary element for various exemplary mass flow rates \dot{m}₁, \dot{m}₂, \dot{m}₃ as a function of gas content, wherein the pressure drop is shown for different flow regimes. It can be clearly seen that the pressure drop increases with increasing gas content at identical mass flow rates \dot{m}ᵢ. The situation is complicated even more by the pressure drop differing at identical gas content and identical mass flow, depending on the flow regime. More precisely, the pressure drop for suspended bubbles, for free bubbles and for so-called slug-flow, is shown in the diagram. It is clearly apparent that the pressure drop at the same gas content increases significantly from flow regime to flow regime at the same gas content.

The aforementioned flow regimes and exemplary signatures of the associated differential-pressure signals are shown in FIGS. 2a to 2c. In the case of the slug-flow shown in FIG. 2a, fluctuations having a comparatively low frequency occur, which frequency scales with the flow rate and the reciprocal of a characteristic length of the slugs. Slugs can have a length of up to several diameters of the measuring tube. The free bubbles shown in FIG. 2b are no longer held by the liquid. This results in pronounced relative movements between the free bubbles and the surrounding liquid. Due to the minimal expansion of the free bubbles compared to the slugs, the signature of the differential-pressure signal has a higher fluctuation frequency and, possibly, lower amplitudes. The signature for suspended microbubbles or a homogeneous medium shown in FIG. 2c substantially corresponds to a noise that, at the given time resolution of a differential-pressure measurement, is barely correlated with the size of microbubbles.

In order to be able to determine a mass flow rate on the basis of a pressure drop during the measurement operation, it is necessary to identify the present flow regime. For this purpose, the described signatures provide a first approach. A second approach for identifying the flow regime is given on the basis of information about the proportion of free and bound bubbles. In the still unpublished patent application DE 102019115215.1, a qualitative representation of the proportion of free bubbles and suspended bubbles is taught. In the still unpublished patent application DE 102019135299.1, a quantitative determination of the proportion of free and bound bubbles is described. A third approach for identifying the flow regime is given by an analysis of fluctuations of the density of the medium or of a vibration frequency of a measuring tube of a Coriolis mass flow meter or density measuring sensor that underlies the density measurement, in which flow meter/sensor the medium is conducted, wherein the fluctuations for slug flow have a different signature than for free or suspended bubbles. Instead of the density, the damping of measuring tube vibrations or the fluctuation of the damping of measuring tube vibrations can also be considered as an indicator for a flow regime. Furthermore, the measuring arrangement for determining the gas volume fractions comprises a pressure sensor. The measured pressure value ascertained thereby and/or its fluctuation can also be used to identify the flow regime. The parameters mentioned can be evaluated individually or in combination in order to identify the flow regime in reference to their relationship.

To implement the identification, a flow regime can first be set under laboratory conditions, wherein the mass flow rate and the gas volume fraction that are possible for a given medium in this flow regime are varied in order to detect associated values for selected ones of the above parameters. This is repeated for various flow regimes. Subsequently, which parameter values are indicative of a given flow regime or enable a unique definition of the flow regime are identified. The parameters or parameter fluctuations that can be detected without additional sensor technology are preferably taken into account.

Thus, for example, the temporal signature of a fluctuation of the density or of the vibration damping standardized with a provisional mass flow rate is an indicator for slug flow, if this corresponds to a characteristic spatial expansion of slugs.

The observed differential-pressure measurement values at a mass flow rate \dot{m} in a multi-phase flow regime of a medium having a given gas content are standardized with the same mass flow rate. The resulting correction factors kᵢ (g) in each case are fitted for various flow regimes with a function of the gas content that is specific for each flow regime:

Thus, the following applies:

$$\frac{{dp}_{i} ( g , dm / dt )}{{dp}_{0} ( g , dm / dt )} = {k}_{i} ( g )$$

In this case, dpᵢ with i element of N denotes a pressure drop at the differential-pressure-generating primary element in the ith multi-phase flow regime, while dm₀ describes the pressure drop for the homogeneous medium, or only with suspended bubbles, wherein g indicates the respective gas content and dm/dt=\dot{m} denotes the mass flow.

The correction factors kᵢ (g) can be placed in a table or recorded as functions, in particular polynomials in g.

By implementation of the functions kᵢ, the correct mass flow \dot{m} can then be ascertained for various flow regimes.

For this purpose, a differential-pressure measurement value is first detected (110). Then a flow regime is identified (120), and the differential-pressure measurement value dpᵢ in any desired flow regime is restored to a standard pressure drop (130) by means of the function kᵢ(g):

$${dp}_{0} ( g , dm / dt ) = \frac{{dp}_{i} ( g , dm / dt )}{{k}_{i} ( g )}$$

Finally, the mass flow rate sought is determined with a function dm/dt (dp₀, g) (140).

1-12. (canceled)

13. A method for measuring a flow of a liquid medium having variable gas content, based on a differential pressure measurement of a differential pressure-generating primary element, through which the medium flows, the method comprising:
determining a differential pressure measurement value between two measuring points of the differential pressure-generating primary element;
determining a flow regime; and
determining a flow rate measurement value as a function of the differential pressure measurement value and the flow regime,
wherein the flow rate measurement value is determined by determining a provisional flow rate measurement value based on the differential pressure measurement value under an assumed first flow regime, which provisional flow rate measurement value is corrected when a second flow regime different from the first flow regime is detected.

14. The method of claim 13, wherein determining the flow regime comprises determining a gas volume fraction.

15. The method according to claim 14, wherein determining the gas volume fraction Preliminary Amendment comprises determining at least one gas volume fraction selected from suspended bubbles, free bubbles and slugs.

16. The method of claim 13, wherein the determining of the flow regime is based on at least one measured variable that characterizes a medium property selected from the group: density, viscosity, temperature, thermal capacity, thermal conductivity, electrical conductivity and pressure.

17. The method of claim 16, wherein the determining of the flow regime comprises an evaluation of temporal fluctuations of the measured variable that characterizes the medium property.

18. The method of claim 16, wherein determining the flow regime comprises determining a gas volume fraction, and wherein the density measurement value and the gas volume fraction are determined using a vibronic measuring sensor, which includes a measuring tube.

19. The method of claim 13, wherein the provisional flow rate measurement value is further determined as a function of a density value and/or a viscosity value.

20. The method of claim 19, wherein the density value and/or the viscosity value are a density measurement value and/or the viscosity measurement value, respectively.

21. The method of claim 13, wherein the correction is performed with a correction factor assigned to the flow regime.

22. The method of claim 21, wherein the correction factor for at least one flow regime comprises a function specific to the flow regime that depends at least on a gas volume fraction.

23. The method of claim 22, wherein the correction factors for a plurality of flow regimes each comprise a function specific to the corresponding flow regime, which depend at least on a gas volume fraction, wherein the functions of different flow regimes differ from each other.

24. The method of claim 13, wherein the first flow regime comprises a flow of a single-phase medium or a medium including suspended microbubbles.
